(19) United States
(12) Patent Application Publication
(10) Pub. No.: US 2014/0110040 A1
(43) Pub. Date: Apr. 24, 2014

(54) IMPRINTED MICRO-LOUVER STRUCTURE METHOD

(71) Applicant: Ronald Steven Cok, Rochester, NY (US)

(72) Inventor: Ronald Steven Cok, Rochester, NY (US)

(21) Appl. No.: 14/060,680

(22) Filed: Oct. 23, 2013

Related U.S. Application Data
(60) Provisional application No. 61/717,162, filed on Oct. 23, 2012.

(51) Int. Cl. G02B 6/00

(52) U.S. Cl. CPC G02B 6/00
USPC 156/182; 427/264; 156/196; 427/532

(57) ABSTRACT

A method of making a micro-louver structure includes coating a curable layer on a surface and imprinting a pattern of micro-channels in the curable layer. The micro-channels have a greater depth than width and are spaced apart by a separation distance greater than the width. The curable layer is at least partially cured to form a cured layer. A light-absorbing material is coated over the cured layer and in the micro-channels and at least a portion of the light-absorbing material removed from the surface of the cured layer leaving at least a portion of the light-absorbing material in the micro-channels. The light-absorbing material is cured to form a light-absorbing structure in each micro-channel.

### CROSS REFERENCE TO RELATED APPLICATION

Reference is made to commonly-assigned U.S. patent application Ser. No. ______ filed concurrently herewith, entitled “Imprinted Micro-Louver Structure” by Ronald S. Cok, the disclosure of which is incorporated herein.

### FIELD OF THE INVENTION

The present invention relates to micro-louver structures.

### BACKGROUND OF THE INVENTION

Micro-louver structures are widely used for privacy screens to inhibit display viewing at large angles from an angle orthogonal to the display. Micro-louver structures are also useful for rejecting specular illumination of a surface at large angles from an angle orthogonal to the surface. For example, U.S. Pat. No. 5,543,870 describes a rear-projection screen with two crossed films of micro-louver light control material to provide a high degree of blocking of high-intensity light, such as sunlight that can impinge upon the front of the screen. U.S. Patent Application Publication 20090242142 describes a vertical micro-louver structure with variable angles or depths. U.S. Patent Application Publication 20080144179 describes a micro-louver sheet including a diffuser layer in a central portion of the sheet to vary the light distribution of the sheet.

Referring to the perspective of FIG. 15, prior-art micro-louver structures are typically composed of alternating portions of a light-absorbing material 84 and a transparent material 86 arranged in a micro-louver sheet 12. The light-absorbing material 84 extends a depth D in a z dimension Z orthogonal to a micro-louver sheet surface 11 of the micro-louver sheet 12 and in a y dimension Y a length L parallel to the micro-louver sheet surface 11 to form parallel micro-louvers 23 extending through and along the micro-louver sheet 12 leaving transparent portions of the micro-louver sheet 12 through which light 50 can pass. The width W of the micro-louvers 23 in an x dimension X parallel to the micro-louver sheet surface 11 and orthogonal to the Y dimension is relatively small compared to the length L of the micro-louvers 23 in the X dimension. It is also desirable that the width W of the micro-louvers 23 is relatively small compared to the depth D or a separation distance S between the micro-louvers 23 in the X dimension. In general, it is useful to make the width W of the micro-louvers 23 as small as possible to increase the transparency of the micro-louver sheet 12 in the Z dimension.

A cross-section A of the micro-louver sheet 12 in a plane parallel to the micro-louver sheet surface 11 has only a small proportion of the light-absorbing material 84 compared to the transparent material 86. Hence, most of the light 54 passing through the micro-louver sheet 12 at an angle orthogonal to the surface of the micro-louver sheet 12 in dimension Z or light 50 emitted parallel to an extensive surface 28 of the light-absorbing material 84 in dimensions Y and Z will pass through the micro-louver sheet 12. In contrast, blocked light 52 passing through the micro-louver sheet 12 at a larger angle to the orthogonal in dimension X or that is not parallel to the extensive surface 28 of the light-absorbing material 84 is absorbed by the light-absorbing material 84. Thus, the blocked light 52 passing through the micro-louver sheet 12 at large angles from a display 40 located adjacent to the micro-louver sheet 12 cannot be seen in the X dimension, while orthogonal emitted light 54 passing through the micro-louver sheet 12 orthogonally to the micro-louver sheet 12 in the Z dimension or parallel to the extensive surface 28 of a light-absorbing material 24 in the Y or Z dimensions can be seen. The micro-louver sheet 12, therefore, forms a privacy screen in the X dimension but not in the Y dimension.

The angle at which the blocked light 52 is absorbed in the X dimension and the transparency of micro-louver sheet 12 in the Z dimension depend upon the depth D and the separation distance S of the micro-louvers 23. In prior-art systems, the micro-louver sheet 12 is laminated to a component of a display 40, for example a display cover 42 through which light is emitted by the display 40. Two privacy screens arranged with micro-louvers 23 at right angles to each other can provide privacy in two orthogonal dimensions.

In one prior-art method described in U.S. Patent Application Publication 20080144179, privacy screens are made by coating a layer of photo-sensitive resin on a first substrate. A mask is used to pattern the photo-sensitive resin. The mask has a pattern corresponding to the arrangement of light-absorbing material 84 and transparent material 86. The pattern is etched into the exposed resin and a layer of curable material is coated over the photo-lithographically etched resin in a vacuum. The curable material is etched to expose the photo-sensitive resin layer, and cured. A transparent second substrate is then laminated to the resin layer. Alternatively, the second substrate is laminated after the resin is etched and curable material wicked into the etched areas using capillary forces, and cured. In yet another method, multiple resin layers having etched areas are laminated together forming gaps and curable material wicked into the gaps using capillary forces, and cured. These methods are limited in the depth they can achieve since photo-lithographic etching has a practical depth limitation or the patterns available are limited to those that can support etching. Furthermore, photo-lithographic processes are relatively expensive and slow.

In other prior-art methods described in U.S. Pat. No. 3,524,789, alternating layers of light-absorbing material 84 and light-transparent material 86 are laminated together, for example as shown in the cross-section A of FIG. 16. Such layers can be formed by extrusion or by laminating pre-formed sheets together, as is also described in European Patent Application No. 466,460. The laminate is then cut into cross-sectional portions, each portion forming the micro-louver sheet 12 with micro-louvers 23 of width W separated by a separation distance S. Alternatively, as illustrated in the perspective of FIG. 17, alternating layers of light-absorbing material 84 and light-transparent material 86 are formed in cylinders and laminated together. Thin micro-louver sheets 12 (not shown) are cut from the cylinder with a knife 70.

These approaches use relatively thick layers of light-absorbing material 84 and light-transparent material 86 that limit the transparency of the resulting micro-louver sheet 12. It is also difficult to make large micro-louver sheets 12 since it is difficult to cut large, thin sheets, for example using skiving. Furthermore, such sheets typically need additional processing to remove curl and polish the edges.

Attributes such as transparency, contrast, or reflectivity are important for optical systems. Overall thickness and cost are also important device attributes.

### SUMMARY OF THE INVENTION

There is a need therefore for micro-louver structures and manufacturing methods providing improved transparency and reduced viewing angle, weight, thickness, and cost.

In accordance with the present invention, a method of making a micro-louver structure comprises:

coating a curable layer on a surface;

imprinting a pattern of micro-channels in the curable layer, wherein the micro-channels have a greater depth than width and are spaced apart by a separation distance greater than the width;

at least partially curing the curable layer to form a cured layer;

coating a light-absorbing material over the cured layer and in the micro-channels;

removing at least a portion of the light-absorbing material from the surface of the cured layer and leaving at least a portion of the light-absorbing material in the micro-channels; and

curing the light-absorbing material to form a light-absorbing structure in each micro-channel.

Structures and methods of the present invention provide improved transparency and reduced viewing angle, weight, thickness, and cost for micro-louver sheets. Improved transparency is provided by enabling reduced micro-louver thickness and fewer layers. Reduced viewing angle is provided by reduced micro-louver thickness, increased micro-louver depth, and multiple micro-louver layers. Reduced weight is provided by reducing the number and thickness of the various layers; reduced cost is achieved through a roll-to-roll manufacturing process that avoids patterned photo-lithographic exposure and etching steps and avoids skiving. Micro-louver sheets of the present invention are useful as privacy screens for display systems in one or two dimensions. In such an application, reduced reflectivity or improved contrast of the micro-louver sheets is desirable, as well as inhibited or restricted display viewing angle.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIG. 1 is a cross-sectional view of a micro-louver structure in an embodiment of the present invention;

FIGS. 2A and 2B are cross-sectional views of micro-louver structures in other embodiments of the present invention;

FIGS. 3-6 are plan views of micro-louver structures in various embodiments of the present invention;

FIG. 7 is a perspective of a micro-louver structure corresponding to FIG. 4 according to an embodiment of the present invention;

FIG. 8 is a cross-sectional view of a micro-louver structure and display in another embodiment of the present invention;

FIGS. 9-11 are cross-sectional views of layered micro-louver structures with different separations and spatial phases in other embodiments of the present invention;

FIGS. 12-14 are flow diagrams illustrating various methods of the present invention;

FIG. 15 is an exploded perspective of a prior-art micro-louver sheet;

FIG. 16 is a cross-sectional view of a prior-art micro-louver structure useful in understanding the manufacture of micro-louver sheets corresponding to FIG. 15; and

FIG. 17 is a perspective of a prior-art micro-louver structure useful in understanding the manufacture of micro-louver sheets.

The Figures are not necessarily to scale, since the range of dimensions in the drawings is too great to permit depiction to scale.

### DETAILED DESCRIPTION OF THE INVENTION

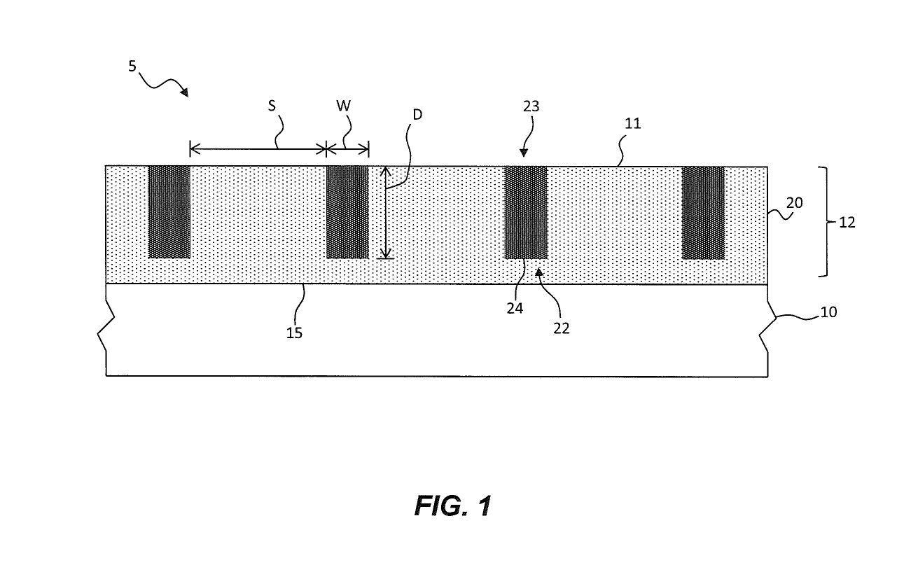

The present invention is directed to micro-louvers formed in sheets. In an embodiment of the present invention illustrated in FIG. 1, a micro-louver structure 5 includes a cured layer 20 on a surface 15, for example the surface 15 of a substrate 10. The cured layer 20 has a plurality of imprinted micro-channels 22 forming a pattern in the cured layer 20. The imprinted micro-channels 22 have a greater depth D than a width W and are spaced apart by a separation distance S greater than the width W of the imprinted micro-channel 22. A cured light-absorbing material 24 is located in the imprinted micro-channels 22. The cured light-absorbing material 24 in the imprinted micro-channels 22 form micro-louvers 23 in the micro-louver sheet 12 including the cured layer 20.

In an embodiment, the cured layer 20 is formed on the surface 15 of the substrate 10. In another embodiment, the imprinted micro-channels 22 and the cured light-absorbing material 24 extend only partially through the cured layer 20 from a surface 11 of the cured layer 20. The surface 11 of the cured layer 20 is also a micro-louver sheet surface 11. The cured layer 20 is substantially transparent, having a transparency greater than or equal to 50%, 70, 80%, 90%, or 95%.

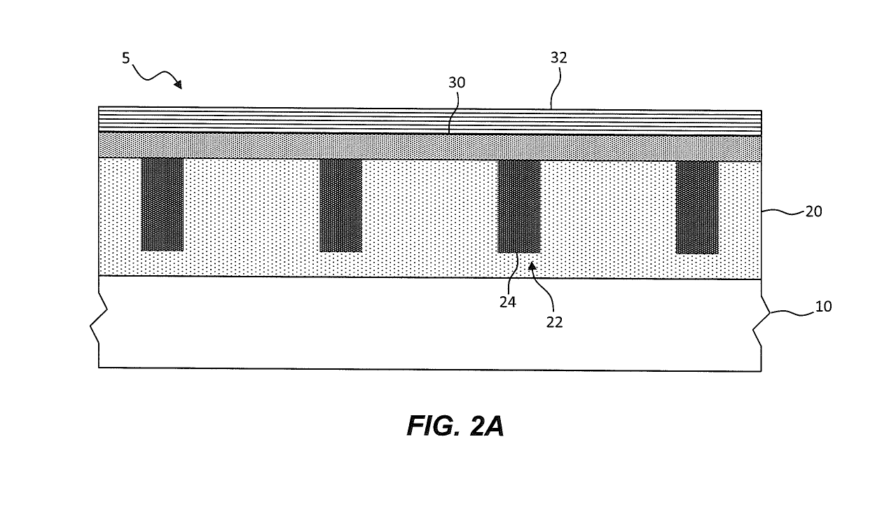

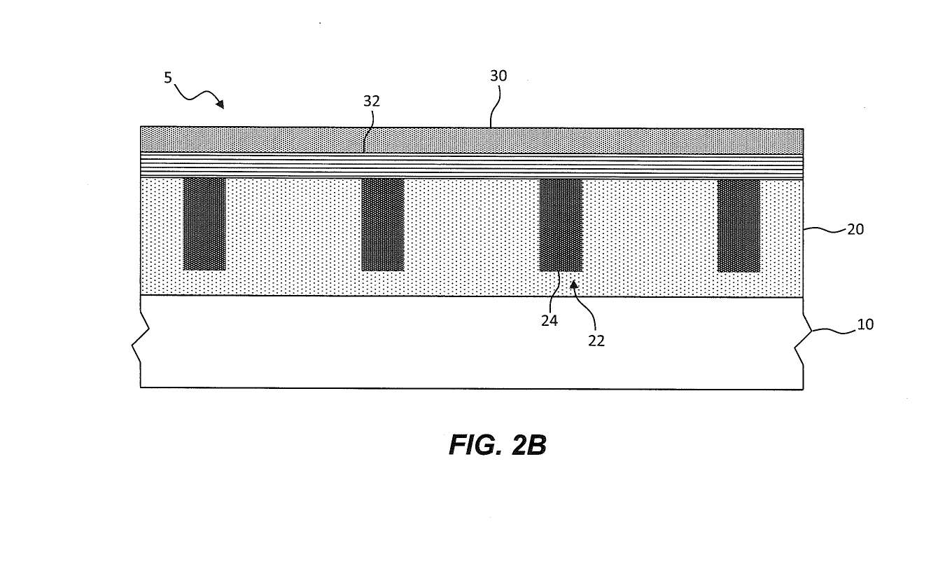

Referring to the cross-sectional view of FIG. 2A, the micro-louver structure 5 includes a protective layer 30 on the cured layer 20 and in contact with the cured light-absorbing material 24 in the imprinted micro-channels 22. In an embodiment, the protective layer 30 is itself a cured layer or includes the same material as the cured layer 20. In alternative embodiments, the protective layer 30 is laminated as a sheet to the micro-louver sheet 12 or is coated as an uncured layer and then cured, for example with radiation. In an embodiment, anti-reflective layers 32 are located on the protective layer 30 opposite the cured layer 20. Referring to FIG. 2B in another embodiment, other layers, for example the anti-reflective layers 32, are located between the protective layer 30 and the cured layer 20 in the micro-louver structure 5 so that the protective layer 30 is not in contact with the light-absorbing material 24. The anti-reflective layers 32 serve to reduce reflections from the surface of the cured layer 20 (FIG. 2B) or protective layer 30 (FIG. 2A).

In an embodiment, an uncured curable layer 20 is coated over the substrate 10 and cured to form cured layer 20. The curable layer 20 can include cross-linking materials that are cured, for example with radiation, to form the cured layer 20. Similarly, uncured curable light-absorbing material 24 is coated over the substrate 10 and cured to form the cured light-absorbing material 24 in the imprinted micro-channels 22. The curable light-absorbing materials 24 can include cross-linking materials that are cured, for example with radiation, to form the cured light-absorbing material 24 and the micro-louvers 23.

As used herein, a cured layer or material is cured in situ after it has been placed in its final location. For example, the curable layer 20 is coated on substrate 10 and then cured. The curable layer 20 is not first cured and then subsequently located on substrate 10. Similarly, the curable light-absorbing material 24 is first located in the imprinted micro-channels 22, for example by coating, and then cured. The curable light-absorbing material 24 is not first cured and then subsequently located in the imprinted micro-channels 22. Such a curing method enables efficient and effective construction of the elements of the present invention. An example of a suitable material for a curable layer is SU8, a well-known material in the photo-lithographic arts. In the Figures, the imprinted micro-channels 22 are indicated with an arrow while the cured light-absorbing material 24 in the imprinted micro-channels 22 is indicated with a lead line. The light-absorbing material 24 in the imprinted micro-channels 22 form the micro-louvers 23. Furthermore, the layer 20 is referred to as both a curable layer 20 and a cured layer 20, depending on whether the material making up the layer 20 has been cured or not. Similarly, the light-absorbing material 24 is referred to as both a curable light-absorbing material 24 and a cured light-absorbing material 24, depending on whether the light-absorbing material 24 has been cured or not.

The substrates 10, for example made of glass or plastic, curable layers 20, for example including curable resins, and curable light-absorbing materials, for example including carbon black in a curable resin, are known in the art as are methods for their preparation, deposition, and curing.

In a further embodiment of the present invention, the cured light-absorbing material 24 is cross-linked to the cured layer 20. In such an embodiment, both the curable light-absorbing material 24 and the curable layer 20 can include cross-linkable materials that cross link when cured. For example, both the curable light-absorbing material 24 and the curable layer 20 can include a common curable resin, for example cured with ultra-violet radiation or heat, that cross links when cured. Such cross-linking between the cured light-absorbing material 24 and the cured layer 20 improves the strength of the micro-louver sheet 12 and improves the scratch resistance of the micro-louvers 23.

In an embodiment of the present invention, the depth D of the imprinted micro-channels 22 (and micro-louvers 23) is at least two times, four times, ten times, fifteen times, twenty times, thirty times, or fifty times greater than the width W. As the depth D of the micro-louvers 23 increases and the width W decreases, the viewing angle of the micro-louver structure 5 decreases and the transparency of the micro-louver structure 5 increases. Therefore, in an embodiment of the present invention, the width W of the imprinted micro-channels 22 is less than or equal to four microns, two microns, or one micron.

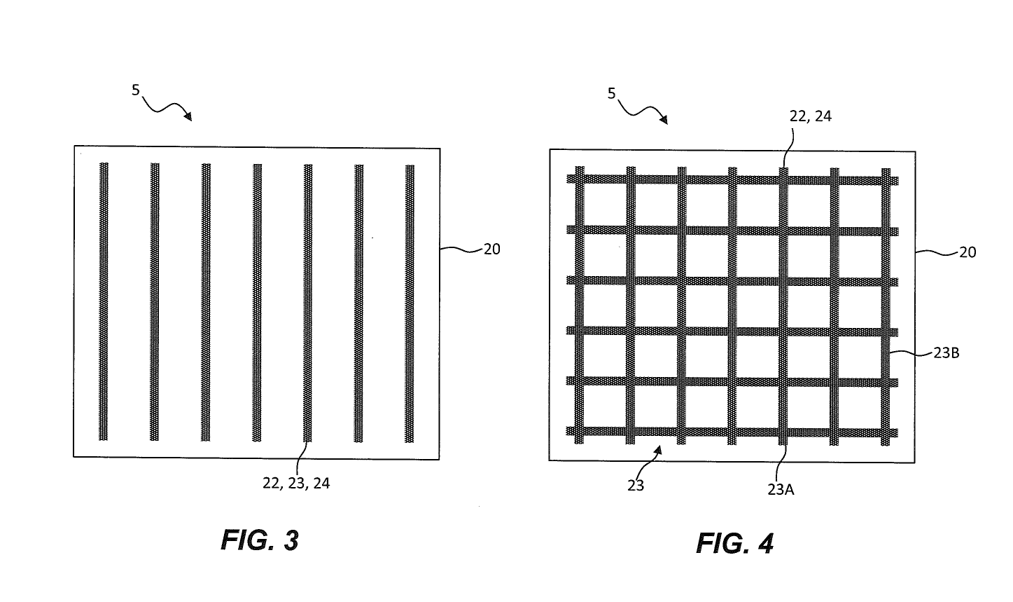

In an embodiment, a cross-section of the imprinted micro-channels 22 in a plane parallel to the micro-louver sheet surface 11 of the cured layer 20 substantially forms an array of lines in one direction. Referring to FIG. 3, the micro-louver structure 5 includes the cured layer 20 having cured light-absorbing material 24 in lines of imprinted micro-channels 22 forming micro-louvers 23. In this embodiment, a privacy screen will limit a user's view in a direction orthogonal to the line direction.

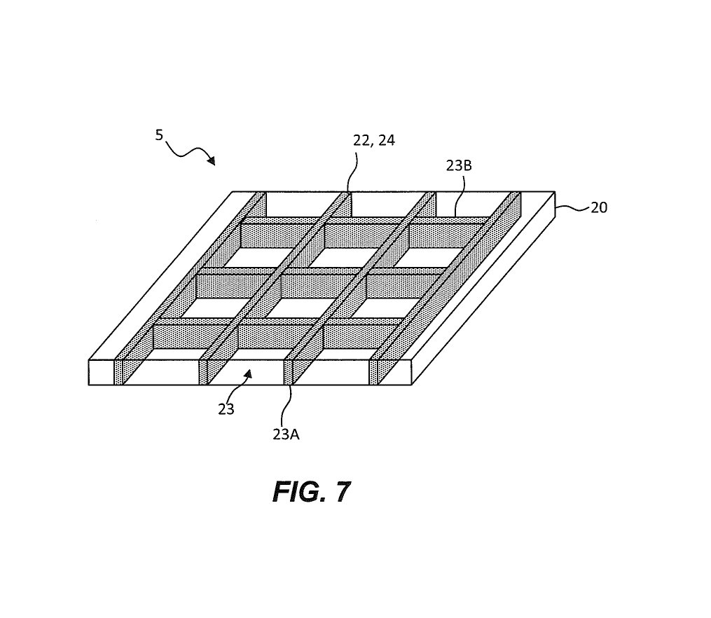

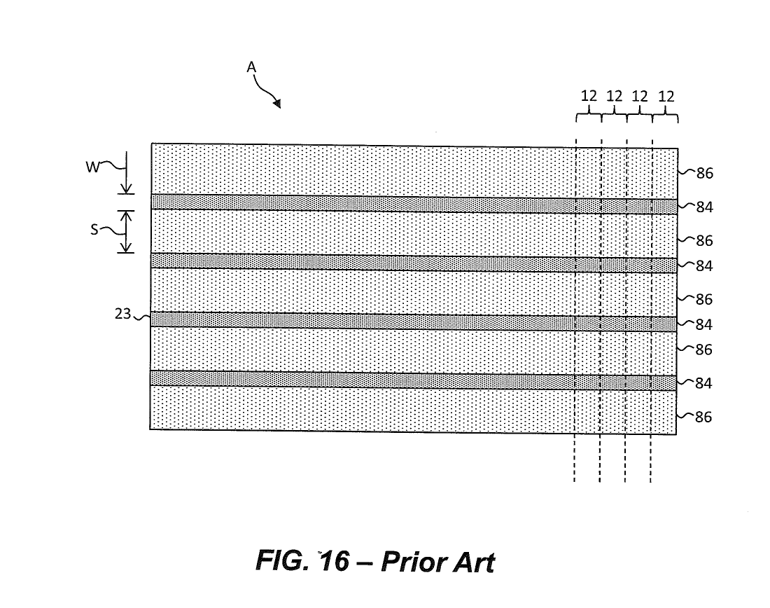

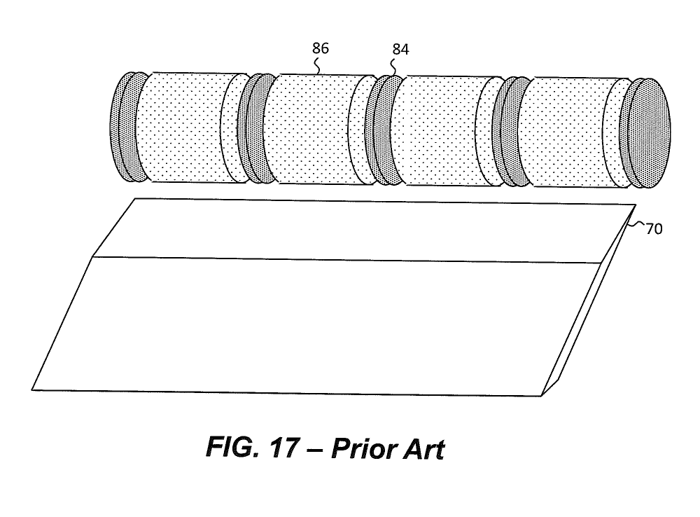

In an alternative embodiment, a cross-section of the imprinted micro-channels 22 in a plane parallel to the micro-louver sheet surface 11 of the cured layer 20 substantially forms rows and columns of lines extending in two different directions forming a grid. Referring to FIG. 4 in a cross-sectional view and to FIG. 7 in perspective, the micro-louver structure 5 includes the cured layer 20 having cured light-absorbing material 24 in lines of imprinted micro-channels 22 forming micro-louvers 23 in two dimensions. Micro-louvers 23A extend in one dimension and micro-louvers 23B extend in an orthogonal dimension. In this embodiment, a privacy screen will limit a user's view in both of two orthogonal directions. Such a structure cannot be made with the prior-art methods illustrated in FIGS. 16 and 17.

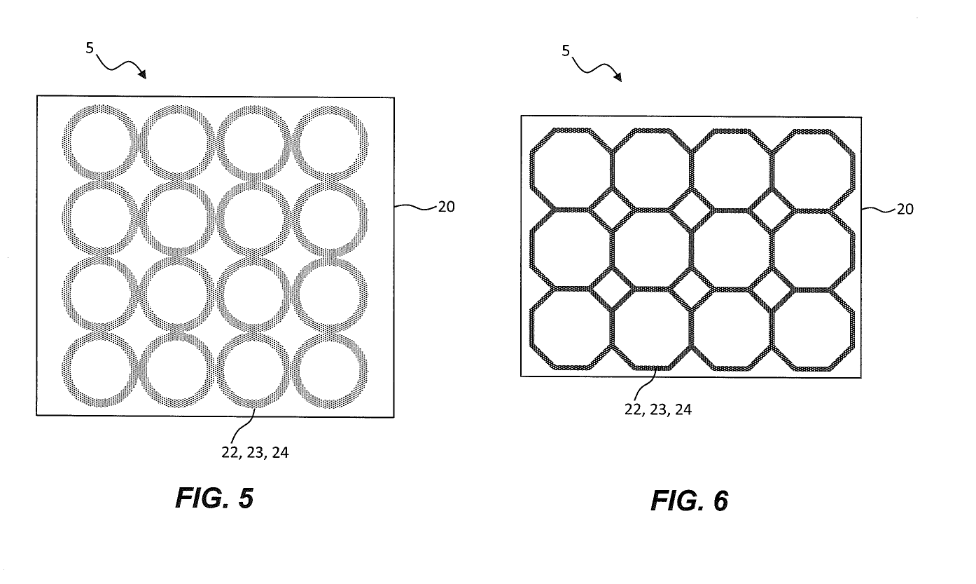

According to various embodiments of the present invention, the micro-louvers 23 need not form straight lines (when viewed in plan view) or portions of a plane (when viewed from the side). For example, referring to FIG. 5, the micro-louver structure 5 includes the cured layer 20 having cured light-absorbing material 24 in circular imprinted micro-channels 22 forming circular micro-louvers 23. Alternatively, referring to FIG. 6, the micro-louver structure 5 includes the cured layer 20 having cured light-absorbing material 24 in octagonal imprinted micro-channels 22 forming octagonal micro-louvers 23. Thus, micro-louvers 23 can form circles, polygons, or other regular or irregular shapes. In some embodiments, the shapes form simple closed curves, in others the shapes are curves, lines, line segments, are interconnected or are separate.

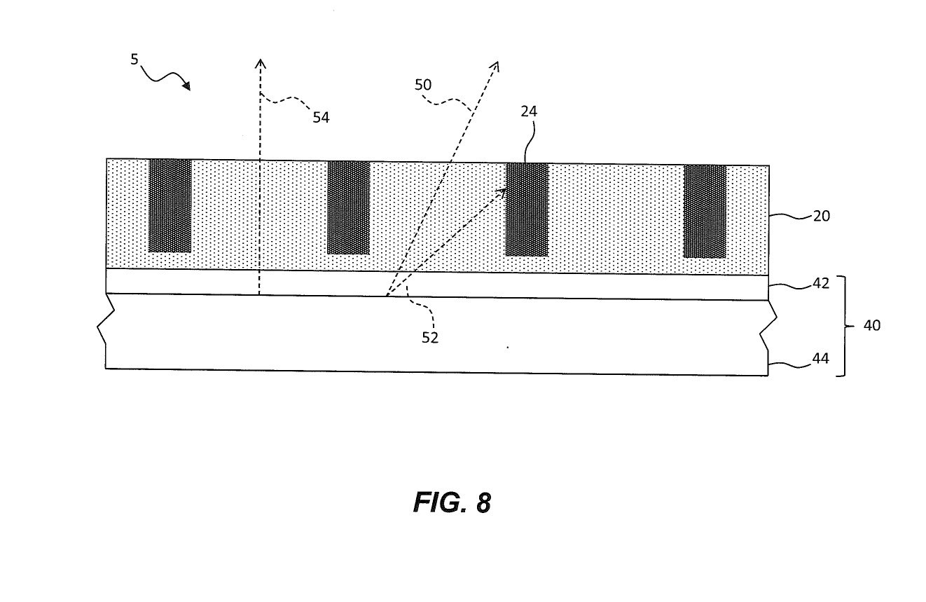

Referring to FIG. 8 in yet another embodiment of the present invention, the micro-louver structure 5 of the present invention is incorporated as a component into a system including the display 40 with a display substrate 44 and the display cover 42. The cured layer 20 is formed on, or laminated to, the display cover 42. In this embodiment, the substrate 10 of FIG. 1 is a component of the display 40 and corresponds to the display cover 42. The display 40 can be, for example, a liquid crystal display or top-emitting organic light-emitting diode (OLED) display. In an alternative embodiment (not shown), the substrate 10 is the display substrate 44, for example in a bottom-emitting OLED display. Other materials or structures are formed in the display 40 between the display cover 42 and the display substrate 44 but are not illustrated, for example electrode layers, backlights, liquid crystal layers, or organic material layers.

As illustrated in FIG. 8, the orthogonal emitted light 54 emitted orthogonally from the display 40 passes through the micro-louver structure 5. The light 50 emitted at a small angle to the display 40 orthogonal also passes through the micro-louver structure 5. However, the blocked light 52 emitted at a large angle to the display 40 orthogonal is absorbed by the light-absorbing material 24 of the micro-louver structure 5. Thus, the micro-louver structure 5 forms a privacy screen for the display 40.

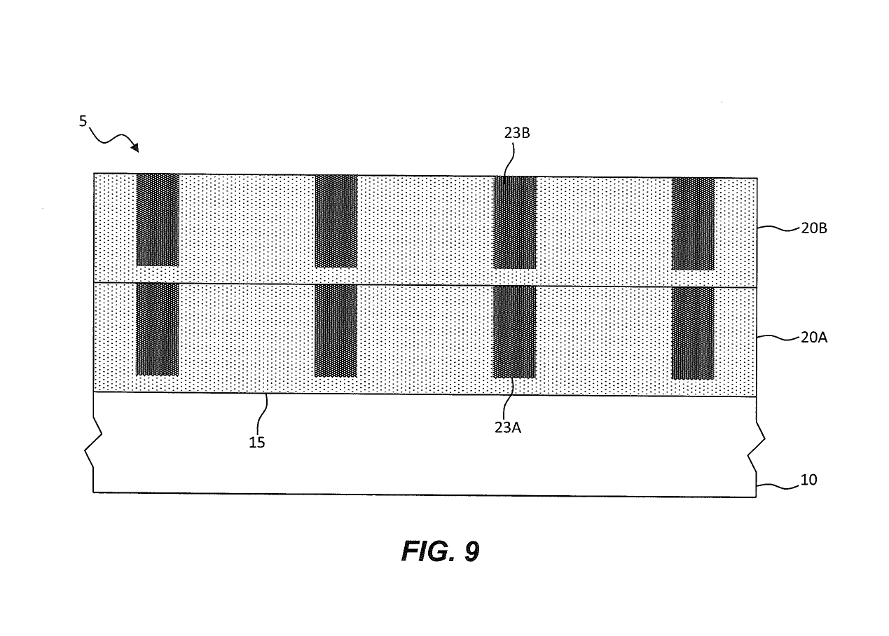

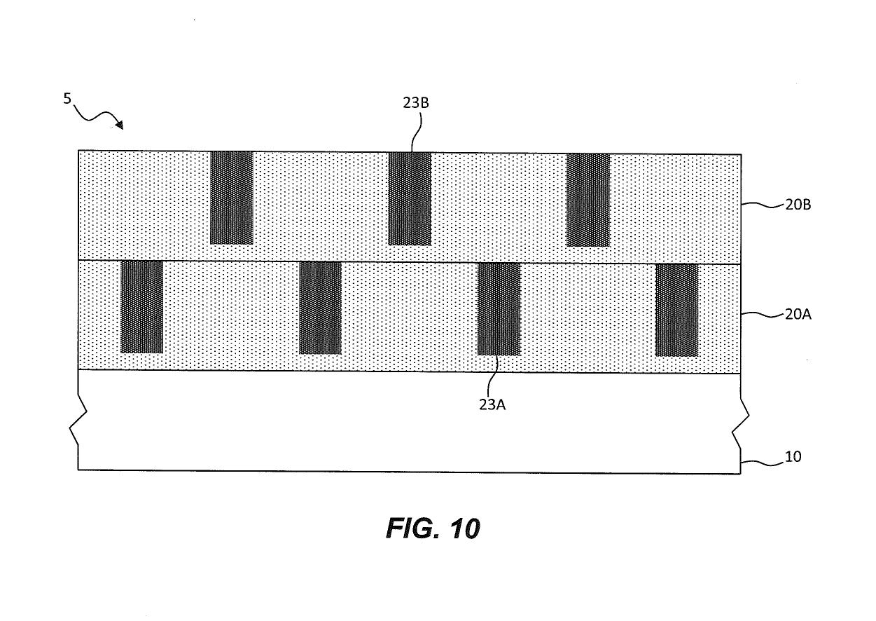

In another embodiment of the present invention, two cured layers 20 are located together in a spatial relationship. As illustrated in FIGS. 9 and 10, the micro-louver structure 5 includes a first cured layer 20A with micro-louvers 23A. The first cured layer 20A is formed on the surface 15 of the substrate 10. A second cured layer 20B with micro-louvers 23B is formed on the substrate first cured layer 20A. As illustrated in FIG. 9, the micro-louvers 23A in the first cured layer 20A are spatially in phase with the micro-louvers 23B in the second cured layer 20B. As illustrated in FIG. 10, the micro-louvers 23A in the first cured layer 20A are spatially out of phase with the micro-louvers 23B in the second cured layer 20B by 180 degrees.

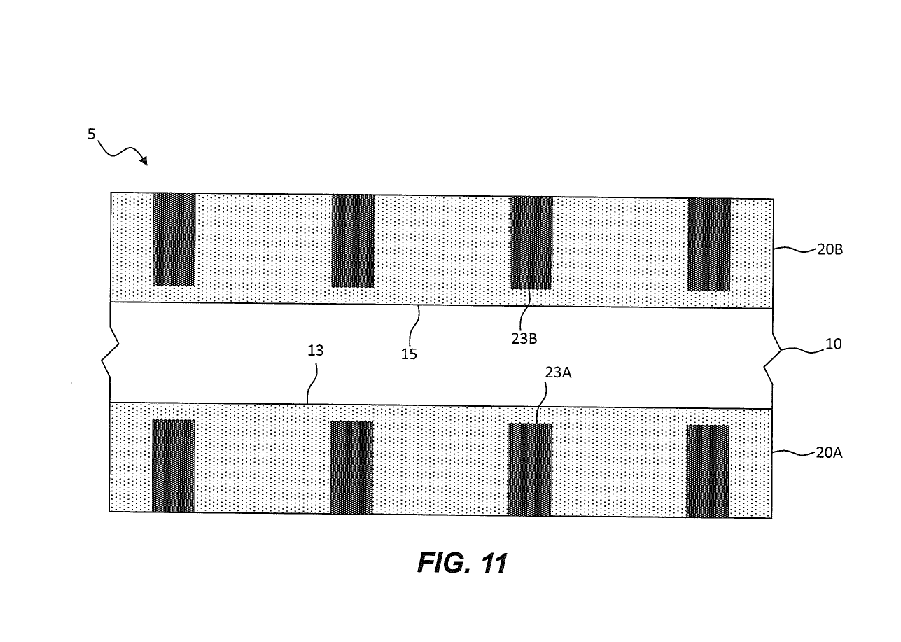

Referring to FIG. 11, the substrate 10 of the micro-louver structure 5 has the substrate surface 15 and an opposed substrate surface 13. In this embodiment, the two cured layers 20A, 20B and the micro-louvers 23A, 23B are located on the opposing surfaces 13, 15 of the substrate 10. As illustrated, the micro-louvers 23A, 23B are spatially in phase, but in an alternative embodiment (not shown), the micro-louvers 23A, 23B are spatially out of phase, for example but not necessarily 180 degrees out of phase.

By locating the micro-louvers 23A and the micro-louvers 23B in a spatial relationship, the effective optical depth of the micro-louvers 23A, 23B is increased, thus reducing further the viewing angle of the micro-louver structure 5. Whether multiple cured layers 20 or in-phase or out-of-phase micro-louvers is desired depends at least in part on the separation distance S, depth D, or width W of the micro-louvers (as shown in FIG. 1), and the desired viewing angle characteristics.

The substrate 10 of FIGS. 9-11 can be a component of the display 40, for example the display cover 42 or the display substrate 44.

A micro-louver structure 5 of the present invention is used by locating the micro-louver structure 5 in an optical system in which it is desired to inhibit transmission through the optical system at large angles to the optical axis. The micro-louver structure 5 can also be used by locating the micro-louver structure 5 over the display 40 and viewing the display 40 and micro-louver structure 5 at an orthogonal to the display 40 and not viewing the display 40 and micro-louver structure 5 at angles that are large with respect to an orthogonal to the display 40.

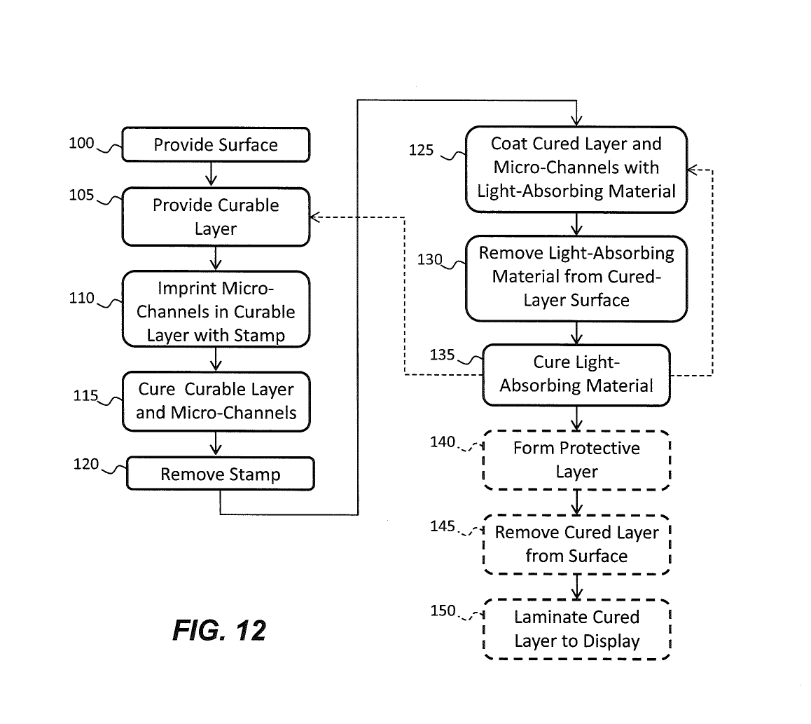

Referring to FIG. 12, a method of the present invention includes making the micro-louver structure 5 that includes providing the substrate surface 15 in step 100. The curable layer 20 is provided in step 105 on the substrate surface 15, for example by coating. A wide variety of coating techniques are available and known in the art, for example spray coating, curtain coating, hopper coating, slot coating, or transfer coating. The curable layer 20 can include a photo-curable or heat-curable resin. Such resins are known in the art.

In step 110, the pattern of micro-channels 22 is imprinted in the curable layer 20. The imprinted micro-channels 22 have a greater depth D than width W and are spaced apart by a separation distance S greater than the width W. The imprinted micro-channels 22 are imprinted using a stamp located in the curable layer 20 and the curable layer 20 is at least partially cured in step 115 to form the cured layer 20. The stamp has a relief pattern that is the inverse of the micro-channel pattern. Imprinted micro-channels 22 having a depth D more than two to six times that of width W for various widths W, for example between 1 and 5 microns, have been demonstrated. Methods for making stamps, locating them in the coated curable layer 20, and curing the curable layer 20 to form the cured layer 20 with micro-channels 22 imprinted therein are known in the art.

In step 120, the stamp is removed leaving the cured layer 20 with imprinted micro-channels 22. A curable light-absorbing material 24 is coated over the cured layer 20 and in the imprinted micro-channels 22 in step 125. At least a portion of the light-absorbing material 24 is removed in step 130 from the micro-louver sheet surface 11 of the cured layer 20 and at least a portion of the light-absorbing material 24 is left in the imprinted micro-channels 22. In step 135, the light-absorbing material 24 is cured to form a light-absorbing micro-louver structure 5 in each micro-channel 22.

In a further embodiment of the present invention, the cured layer 20 is optionally polished or an optional protective layer 30 is formed in step 140. Alternatively, the cured layer 20 is removed from the substrate surface 15 (step 145) and laminated to another surface (step 150). For example, the cured layer 20 is laminated to the display cover 42 or display substrate 44.

As shown in FIG. 12, the steps 125, 130, and 135 of coating the cured layer 20 and the imprinted micro-channels 22 with the curable light-absorbing material 24, removing the excess curable light-absorbing material 24 from the cured-layer surface 11, and curing the light-absorbing material 24 are repeated as necessary to fill the imprinted micro-channels 22 with cured light-absorbing material 24.

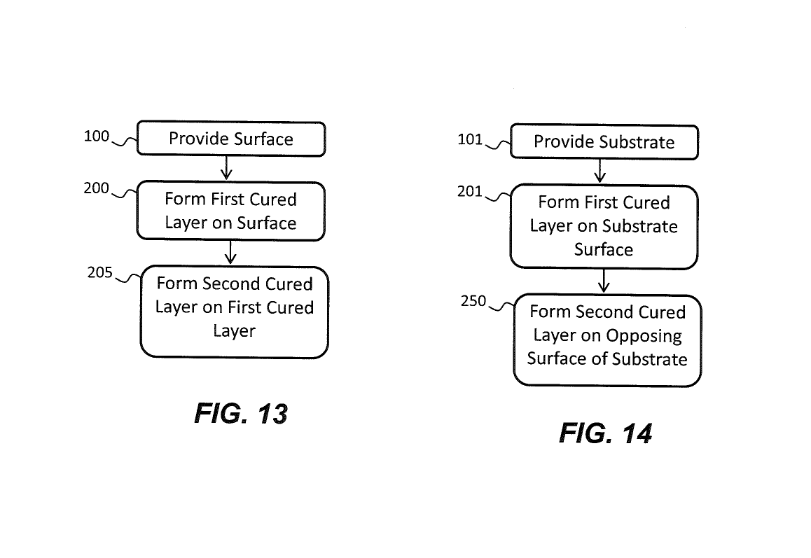

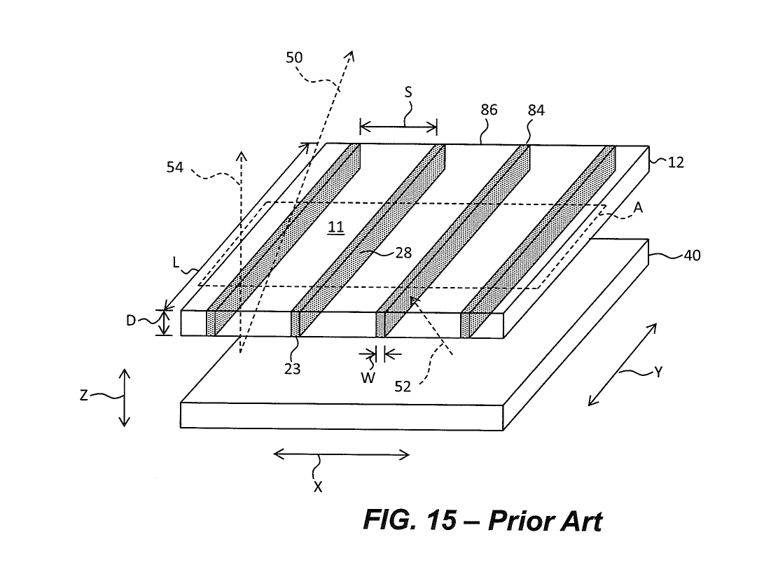

In another embodiment, multiple layers 20 of cured material are iteratively coated over the cured layer 20 (step 105), imprinted (step 110), cured (step 115), the imprinting stamp removed (step 120), the cured layer 20 coated with light-absorbing material 24 (step 125), excess light-absorbing material 24 removed (step 130) and cured (step 135) to create micro-louver structures 5 such as those illustrated in FIGS. 9 and 10. As illustrated in FIG. 13, multiple layers 20 of cured material are provided. In step 100, the substrate surface 15 is provided. The first cured layer 20A is formed on the substrate surface 15 in step 200 (including steps 105-135 of FIG. 12). The second cured layer 20B is formed in step 205 (including the same steps as for the first cured layer 20A) on the first micro-louver sheet surface 11.

Alternatively, a micro-louver structure 5 is formed on either side of the substrate 10. As illustrated in FIG. 14, a substrate 10 having two opposing substrate surfaces 13, 15 is provided in step 101. The first cured layer 20A is formed on the substrate surface 13 in step 201 (including steps 105-135 of FIG. 12). The second cured layer 20B is formed on the opposing substrate surface 15 in step 250 (including the same steps as for the first cured layer 20A).

In various embodiments, the curable layer 20 or the light-absorbing material 24 is provided including cross-linking materials. The curable layer 20 or the light-absorbing material 24 is cured with electromagnetic radiation or heat. In one embodiment, the step of curing the light-absorbing material 24 also at least partially cures the curable layer 20 so that the curable layer 20 is cross linked to the light-absorbing material 24.

In other embodiments, methods of the present invention include forming the depth of the imprinted micro-channels 22 to be at least two times greater than the width of the imprinted micro-channels 22, four times greater than the width, five times greater than the width, eight times greater than the width, or ten times greater than the width. In another embodiment, a method of the present invention includes forming the width of the imprinted micro-channels 22 to be less than or equal to four microns, two microns, or one micron. In another embodiment of the present invention, a method includes forming imprinted micro-channels 22 so that a cross-section of the imprinted micro-channels 22 in a plane parallel to the surface of the cured layer 20 substantially forms an array of lines in one direction (as illustrated in FIG. 3). Alternatively, a method includes forming imprinted micro-channels 22 so that a cross-section of the imprinted micro-channels 22 in a plane parallel to the surface of the cured layer 20 substantially forms a grid in one direction (as illustrated in FIG. 4). In other embodiments, methods of the present invention include forming imprinted micro-channels 22 so that a cross-section of the imprinted micro-channels in a plane parallel to the surface of the cured layer 20 substantially forms one or more polygons (as shown in FIG. 6) or one or more circles (as shown in FIG. 5).

In another embodiment of the present invention, the imprinted micro-channels 22 are formed to extend only partially through the curable layer 20, as illustrated in FIG. 1.

Another method of the present invention included laminating two or more micro-louver structures 5 together or forming two micro-louver structures 5 and laminating the two micro-louver structures 5 together (as shown in FIG. 9). The step of laminating can further include laminating the two micro-louver structures 5 together spatially in phase or spatially 180 degrees out of phase (as shown in FIGS. 9 and 10). Alternatively, a method of the present invention can further include providing the substrate 10 and forming two micro-louver structures 5 on opposing substrate surfaces 13, 15 of the substrate 10. The micro-louver structures 5 can be formed spatially in phase or spatially 180 degrees out of phase.

A method of making a micro-louver structure 5 for use with the display 40 that permits orthogonal display viewing while inhibiting display viewing at larger angles to the orthogonal includes forming the micro-louver structure 5 by coating the curable layer 20 on a surface, for example a substrate surface 15 and imprinting a pattern of micro-channels 22 in the curable layer 20. The imprinted micro-channels 22 have a greater depth D than width W and are spaced apart by a separation distance S greater than the width W. The curable layer 20 is at least partially cured to form a cured layer 20 that is coated with a light-absorbing material 24 in the imprinted micro-channels 22. At least a portion of the light-absorbing material 24 is removed from the micro-louver sheet surface 11 of the cured layer 20 leaving at least a portion of the light-absorbing material 24 in the imprinted micro-channels 22. The light-absorbing material 24 is cured to form a light-absorbing structure forming a micro-louver 23 in each imprinted micro-channel 22. The micro-louver structure 5 is located on a viewing surface of the display 40, whereby orthogonal display viewing is enabled while display viewing at larger angles is inhibited. Alternatively, the micro-louver structure 5 is formed on a substrate 10 that is an element of the display 40, for example the display cover 42 or display substrate 44.

According to various embodiments of the present invention, a substrate 10 is any material having the substrate surface 15 on which the curable layer 20 can be formed. For example, glass and plastic are suitable materials known in the art from which the substrates 10 can be made into sheets of material having substantially parallel opposed sides, one of which is the substrate surface 15. In various embodiments, substrate 10 is rigid, flexible, or transparent.

The substrate 10 can have a wide variety of thicknesses, for example 10 microns, 50 microns, 100 microns, 1 mm, or more. In various embodiments of the present invention, the substrate 10 is provided as an element of other devices, for example the display cover 42 or display substrate 44 of the display 40 or the curable layer 20 is coated on another underlying substrate 10, for example by coating the curable polymer layer on an underlying glass substrate 10, such as the display cover 42. Alternatively, the substrate 10 can be affixed to the display 40 or other device.

An imprinted micro-channel 22 is a groove, trench, or channel formed in the curable layer 20 and extending from the cured-layer surface 11 toward substrate 10 and having a cross-sectional width W, for example less than or equal to 20 microns, 10 microns, 5 microns, 4 microns, 3 microns, 2 microns, 1 micron, or 0.5 microns. In an embodiment, the cross-sectional depth D of the imprinted micro-channel 22 is greater than or equal to twice the width W, five times the width W, ten times the width W, fifteen times the width W, twenty times the width W, thirty times the width W, or fifty times the width W. The micro-channels 22 can have a rectangular cross-section, as shown. Other cross-sectional shapes, for example trapezoids, are known and are included in the present invention.

Material compositions useful in the curable layer 20 or the curable light-absorbing material 24 can be provided in one state and then processed into another state, for example converted from a liquid state into a solid state. Such conversion can be accomplished in a variety of ways, for example by drying or heating. Furthermore, useful material compositions can include a set of materials that, after deposition and processing, is reduced to a subset of the set of materials, for example by removing solvents from the material composition. For example, a material composition including a solvent is deposited and then processed to remove the solvent leaving a material composition without the solvent in place. Thus, according to embodiments of the present invention, a material composition that is deposited on the substrate 10 or in the imprinted micro-channels 22 is not necessarily the same composition as that found in the cured material composition.

In one embodiment, the light-absorbing material 24 includes carbon black, a black dye, or a black pigment. In another embodiment, the light-absorbing material 24 includes a colored dye or a colored pigment other than black. U.S. Patent Application Publication No. 2008/0257211 discloses a variety of metallic colored inks and its contents are hereby incorporated by reference. In a further embodiment, the substrate 10 and the cured layer 20 are substantially transparent.

Curing material compositions such as those in the curable layer 20 or in the curable light-absorbing material 24 can be done by drying or heating in stages. In particular, if the curable layer 20 is a polymer layer, heating the polymer layer slightly can soften the polymer so that particles, for example black pigment or carbon black particles in the light-absorbing material 24 can adhere to the polymer. Such heating can be done by convective heating (putting substrate 10 into an oven) or by infrared radiation. Heating with infrared radiation has the advantage that light-absorbing particles, for example black particles, differentially absorb the infrared radiation and heat up more than substrate 40 or curable layer 20 (that can be transparent), thus providing a more efficient adhesion or drying process for a material composition. Adhesion of the curable layer 20 to the light-absorbing material 24 is advantageous because such adhered materials are more resistant to mechanical abrasion and are thus more environmentally robust.

Methods and device for forming and providing substrates, coating substrates, patterning coated substrates, or pattern-wise depositing materials on a substrate are known in the photo-lithographic arts. Likewise, tools for laying out electrodes, conductive traces, and connectors are known in the electronics industry as are methods for manufacturing such electronic system elements. Hardware controllers for controlling touch screens and displays and software for managing display and touch screen systems are all well known. All of these tools and methods can be usefully employed to design, implement, construct, and operate the present invention. Methods, tools, and devices for operating capacitive touch screens can be used with the present invention.

The present invention is useful in a wide variety of electronic devices. Such devices can include, for example, photovoltaic devices, OLED displays and lighting, LCD displays, plasma displays, inorganic LED displays and lighting, electrophoretic displays, electrowetting displays, dimming mirrors, smart windows, transparent radio antennae, transparent heaters and other touch screen devices such as resistive touch screen devices.

The invention has been described in detail with particular reference to certain embodiments thereof, but it will be understood that variations and modifications can be effected within the spirit and scope of the invention.

### PARTS LIST

A cross-section
D depth
L length
S separation distance
W width
X x dimension
Y y dimension
Z z dimension
5 micro-louver structure
10 substrate
11 surface
12 micro-louver sheet
13 opposed substrate surface
15 substrate surface
20 curable/cured layer
20A first curable/cured layer
20B second curable/cured layer
22 imprinted micro-channel
23 micro-louver
23A micro-louver
23B micro-louver
24 light-absorbing material
26 transparent material
28 extensive surface
30 protective layer
32 anti-reflective layer
40 display
42 display cover
44 display substrate
50 light
52 blocked light
54 orthogonal emitted light
70 knife
84 light-absorbing material
86 transparent material
100 provide surface step
101 provide substrate step
105 provide curable layer step
110 imprint micro-channels in curable layer with stamp step
115 cure curable layer and micro-channels step
120 remove stamp step
125 coat cured layer and micro-channels with light-absorbing material step
130 remove light-absorbing material cured-layer surface step
135 cure light-absorbing material step
140 optional form protective layer step
145 remove cured layer from surface step
150 laminate cured surface to display step
200 form first cured layer on surface step
201 form first cured layer on substrate surface step
205 form second cured layer on first cured layer step
250 form second cured layer on opposing surface of substrate step

1. A method of making a micro-louver structure, comprising:
coating a curable layer on a surface;
imprinting a pattern of micro-channels in the curable layer, wherein the imprinted micro-channels have a greater depth than width and are spaced apart by a separation distance greater than the width;
at least partially curing the curable layer to form a cured layer;
coating a light-absorbing material over the cured layer and in the imprinted micro-channels;
removing at least a portion of the light-absorbing material from the surface of the cured layer and leaving at least a portion of the light-absorbing material in the imprinted micro-channels; and
curing the light-absorbing material to form a light-absorbing structure in each imprinted micro-channel.

2. The method of claim 1, further including coating a light-absorbing material over the cured layer and in the micro-channels a second time.

3. The method of claim 1, further including polishing the surface of the cured layer.

4. The method of claim 1, further including removing the cured layer from the surface and laminating the cured layer to another surface.

5. The method of claim 1, further including providing a protective layer on the cured layer.

6. The method of claim 1, further including curing the curable layer with electromagnetic radiation or heat.

7. The method of claim 1, further including curing the light-absorbing material with electromagnetic radiation or heat.

8. The method of claim 1, further including providing the light-absorbing material with cross-linking materials.

9. The method of claim 8, wherein the curable layer includes cross-linking materials and further including curing the light-absorbing material simultaneously with at least partially curing the curable layer.

10. The method of claim 9, further including cross linking the curable layer to the light-absorbing material.

11. The method of claim 1, further including forming the depth of the imprinted micro-channels at least two times greater than the width, four times greater than the width, five times greater than the width, eight times greater than the width, ten times greater than the width, fifteen times greater than the width, twenty times greater than the width, thirty times greater than the width, or fifty times greater than the width.

12. The method of claim 1, further including forming the width of the micro-channels less than or equal to four microns, two microns, or one micron.

13. The method of claim 1, further including substantially forming an array of lines in one direction in the cured layer with a cross-section of the imprinted micro-channels in a plane parallel to the surface of the cured layer.

14. The method of claim 1, further including substantially forming a grid in the cured layer with a cross-section of the imprinted micro-channels in a plane parallel to the surface of the cured layer.

15. The method of claim 1, further including substantially forming one or more polygons or one or more circles with a cross-section of the imprinted micro-channels in a plane parallel to the surface of the cured layer.

16. The method of claim 1, further including forming the imprinted micro-channels to extend only partially through the curable layer.

17. The method of claim 1, further including forming two micro-louver structures and laminating the two micro-louver structures together.

18. The method of claim 17, further including laminating the two micro-louver structures together spatially in phase or spatially 180 degrees out of phase.

19. The method of claim 17, further including providing a substrate and forming two micro-louver structures on opposing surfaces of the substrate.

19. The method of claim 19, further including forming the two micro-louver structures spatially in phase or spatially 180 degrees out of phase.

20. A method of making a micro-structure for use with a display which permits orthogonal display viewing while inhibiting display viewing at larger angles, comprising:
forming the micro-structure by:
coating a curable layer on a surface;
imprinting a pattern of micro-channels in the curable layer, wherein the imprinted micro-channels have a greater depth than width and are spaced apart by a separation distance greater than the width;
at least partially curing the curable layer to form a cured layer;
coating a light-absorbing material over the cured layer and in the imprinted micro-channels;
removing at least a portion of the light-absorbing material from the surface of the cured layer and leaving at least a portion of the light-absorbing material in the imprinted micro-channels; and
curing the light-absorbing material to form a light-absorbing structure in each imprinted micro-channel; and
locating the micro-structure on a viewing surface of the display, whereby orthogonal display viewing is enabled while display viewing at larger angles is inhibited.
